(19) United States
(12) Patent Application Publication
(10) Pub. No.: US 2010/0280839 A1
(43) Pub. Date: Nov. 4, 2010

(54) Collaboration for Excellence: An Integrated Method for Providing the Best Patient Experience

(76) Inventors: Rose Lenore Katz, Cleveland, OH (US); Janice Ann Moellering, St. Louis, MO (US); Kathy Therese Black, Palos Park, IL (US)

Correspondence Address: COZEN O'CONNOR, P.C., 1900 MARKET STREET, PHILADELPHIA, PA, 19103-3508, US

(21) Appl. No.: 12/694,573

(22) Filed: Jan. 27, 2010

Related U.S. Application Data
(60) Provisional application No. 61/147,814, filed on Jan. 28, 2009.
(60) Provisional application No. 61/147,642, filed on Jan. 27, 2009.

(51) Int. Cl. G06Q 50/00; G06F 21/00; G06F 15/16; G06Q 10/00

(52) U.S. Cl. 705/2; 726/4

(57) ABSTRACT

A system and method to perform the collaboration for excellence integrated method are provided. The computer system comprises at least one controller adapted to perform the collaboration for excellence integrated method for providing the best patient experience. The method further comprises the steps of prioritizing and determining a target entity; establishing a road map with said entity; performing an initial assessment of critical issues; performing a discovery process; designing an action plan; and driving the outcomes and measuring progress. The Nursing Satisfaction with Support Services (NS3) survey is a tool used to perform one of the many analyses that are part of this process.

### CROSS REFERENCE TO RELATED APPLICATIONS

This application claims priority to U.S. Application Ser. No. 61/147,814, filed on Jan. 28, 2009, and claims priority to U.S. Application Ser. No. 61/147,642, filed on Jan. 27, 2009, both the contents of which are herein incorporated by reference in their entireties.

### FIELD OF THE INVENTION

The present invention is directed to health care in general and in particular to a system for performing the collaboration for excellence integrated method thereby providing the best patient care.

### BACKGROUND OF THE INVENTION

In 2010, there will most likely not be enough healthcare workers to deliver care using the same models used today.

Despite individual examples of success, healthcare costs continue to rise annually on average. Moreover, the satisfaction of patients with the care received at clinics is, in general decreasing. Moreover, the job satisfaction level of many employees, such as nurses and medical technicians, is relatively low.

Everyone in the health care industry is faced with two simple facts: they have to cut costs while maintaining high quality services. Patients, employers, business groups, health plans, and insurers are scrutinizing the delivery of health care from both a quality and cost perspective.

The work of the future must first be defined; then the roles needed to do that work, followed by the education that is required to create the role to do the work.

Dramatic change and revolutionary thinking are imperative. The delivery models for the future will require that we work collaboratively in multidisciplinary teams. Hospital leaders play a vital role in setting expectations and creating a culture that fosters strong, collaborative relationships between nursing and healthcare professionals. As leaders within their organization, Nurse Executives must serve as the catalyst for change by advocating and nurturing stronger relationship between nursing and support services in the clinical setting. Meaningful change will require significant effort at all levels of the organization.

### SUMMARY OF THE INVENTION

The present method and system for creating a patient care environment that is collaborative, respectful, and positive in providing the best patient care. Specifically, the various embodiments provide an environment that is suited to the shared purpose of caring for patients and their families. The various embodiments enable nurses to spend more time with patients by keeping supplies and equipment at hand and bringing services to the patient. The various embodiments further create a work environment that addresses the physical and emotional needs of staff. The desired results will be decreased mortality and infection rates, increased patient satisfaction, increased nursing satisfaction, decreased turnover of employees, and improved clinical outcomes.

According to one aspect of the present embodiments, there is provided a collaboration for excellence integrated method for providing the best patient experience, comprising the steps of selecting a target entity; designing an action plan; performing an initial assessment of critical issues; and driving the outcomes and measuring progress. The collaboration for excellence integrated method further comprises the steps of determining and prioritizing the target entity based on pre-determined criteria; pre-intervention communication and intervention; performing one or more discovery steps; performing one or more activities including analyzes, studies, surveys, evaluations and data collection; executing the Nursing Satisfaction with Support Services (NS3) survey; and communicating the outcomes of said analyses to said entity. The Nursing Satisfaction with Support Services (NS3) survey is a tool used to perform one of the many analyses that are part of this process.

According to another aspect of the present embodiments, there is provided a collaboration for excellence system, comprising at least one controller communicatively coupled to one or more target entities wherein the controller is adapted to perform a collaboration for excellence integrated method for providing the best patient experience. The system further comprising a database, accounting, authorization and authentication (AAA) server communicatively coupled to the at least one controller; and a remote access device communicatively coupled to the at the least one controller.

### DESCRIPTION OF THE DRAWINGS

The above and other objects, features and other advantages of the present embodiments will be more clearly understood from the following detailed description taken in conjunction with the accompanying drawings, in which:

FIG. 1 depicts a block diagram of the Collaboration for Excellence system according to one embodiment;

FIG. 2 depicts the Flow Chart of the Collaboration for Excellence Integrated Method Discovery Process according to one embodiment;

FIG. 3 depicts Step #1 Flow Chart of the Collaboration for Excellence Integrated Method Discovery Process according to one embodiment;

FIGS. 4A and 4B depict Step #2 Flow Chart of the Collaboration for Excellence Integrated Method Discovery Process according to one embodiment;

FIG. 5 depicts Step #3 Flow Chart of the Collaboration for Excellence Integrated Method Discovery Process according to one embodiment;

FIG. 6 depicts the Documents Needed for Review according to one embodiment;

FIGS. 7A and 7B depict Step #4a Flow Chart of the Collaboration for Excellence Integrated Method Discovery Process according to one embodiment;

FIGS. 8A and 8B depict Step #4b Flow Chart of the Collaboration for Excellence Integrated Method Discovery Process according to one embodiment;

FIG. 9 depicts Step #5 Flow Chart of the Collaboration for Excellence Integrated Method Discovery Process according to one embodiment;

FIGS. 10A and 10B depict Step #6 Flow Chart of the Collaboration for Excellence Integrated Method Discovery Process according to one embodiment; and

FIGS. 11A, 11B and 11C depict Step #7 Flow Chart of the Collaboration for Excellence Integrated Method Discovery Process according to one embodiment.

To facilitate understanding, identical reference numerals have been used, where possible, to designate identical elements that are common to the figures.

### DETAILED DESCRIPTION OF THE PREFERRED EMBODIMENTS

Although various embodiments are primarily described within the context of a collaborative patient care environment; however, those skilled in the art and informed by the teachings herein will realize that the disclosed embodiments are applicable to any service environment.

Fundamentally, nursing must continue to focus on clinical care functions. However, in an ever-changing and increasingly resource-constrained environment, the clinical and critical thinking skills of nurses must be supported by stronger collaboration with support services in the clinical setting.

### DEFINITIONS

LOS—Line of Service. This refers to specific services provided at client locations, typically bucketed in three areas: food and nutrition services, facility management, and clinical technology services (CTS).

Director/Operations Report—standard report form that varies by service line. This report provides a comprehensive assessment of operations based on service line standards and compliance.

Blue Sheet—The Blue Sheet planning tool is copyrighted by Miller Heiman Corporation and used to empower sellers to build and maintain a strategic approach to pursuing opportunities. The Blue Sheet gives sales people an easy and user-friendly way to build strategies for individual opportunities moving them to close faster, taking into account various buyer roles within a complex task force.

Rounding Logs: Managers and supervisors are required to round on employees regularly. When rounding, there are prescribed questions that should be asked of each employee. Logs contain notes from these rounding conversations and provide ways to capture feedback, input, and initiate actions in areas identified during rounding. Logs are to be reviewed by management when they visit the account.

Hotline Concerns: A hotline is maintained for employees to use in the event of questions or concerns. As part of the discovery process, the organization effectiveness coordinator reviews these logs to determine if any concerns about unethical or inappropriate conduct have been reported to aid in the assessment of the team.

Employee Satisfaction Scores: Whether scores are available from third-party companies like Jackson or Gallup or whether employee satisfaction has been measured by an internal tool, this data is used as an input to evaluate current operations and turnover, as well as to better understand the link from employee satisfaction to patient and family satisfaction.

Patient Satisfaction Scores: One of the most important outcomes to impact is patient satisfaction. These scores are reviewed with clients, and action plans are put in place as interventions that will help move patient satisfaction scores and rank up. In some cases, these scores form part of a contractual incentive with clients to insure alignment with operations.

Organization chart with FTE Scope: The organization chart of each hospital is always reviewed as part of the discovery process so that the OD can better understand scope of command, line of sight to leadership, and perhaps most importantly staffing ratios. Structure and employee counts will, of course, vary by hospital, type of healthcare delivered, and number of beds.

Financial Indicators: Growth and financial goals are determined for each hospital (clinic) location. Each hospital also has a budget, established by service line in the event of multiple service delivery. Financial indicators vary by service line, but common indicators compare plan to actual for hospital budget, revenue, and front-line contribution. Other indicators may be food costs, cost per patient day, cost per square foot, etc.

PSP: Partnership Success Plan (PSP) is a program designed to focus on the needs, expectations, and satisfaction levels of the clients and customers. It is set forth in Table 1. As a step-by-step guide, PSP is utilized to build deep and lasting partnerships with clients. It is a continuous, looped process that can be implemented every day. PSP should ultimately guide thoughts and actions regarding the management of client and customer relationships, becoming a part of the consciousness of the manager along the way.

Recent QPQ: Quality Performance Quotient (QPQ) is an objective 1,000-point inspection conducted by a qualified representative and the on-site manager. The inspection is used as an objective comparison to measure the progress of the program.

Collaboration for Excellence Model: The subject of this patent. Used to identify ways that nursing can work with support service departments to create a more collaborative work environment that is focused on delivering patient care.

Organization Effectiveness Report—This report is the result of several visits, interviews, and rounding that can help identify integration of new team members, assess the strength of the leadership team, and evaluate priorities and change management. The report identifies a baseline evaluation in six areas: communication, change and transition, leadership and people development, team relationship building, vision/mission alignment, and service quality. The report also identifies next steps and dates for activities growing out of the assessment.

I-impact site visit report—This report evaluates I impact behaviors at each location, as well as degree of hardwiring of same behaviors. Based on observation, interactions, and rounding, this report lists wins and opportunities, as well as identifies next steps. Items reviewed include 90-day plans. Table 3 provides examples of some things to consider for the 90-day plan.

Team scale assessment—A quantitative tool to help organization effectiveness coordinators evaluate team dynamics. This tool was developed by Project Adventure, Inc., “Qualities of Effective Teams” (incorporated herein by reference).

Scorecard.” Application by which front-line managers (FLM) track their scores against annual and long-term goals. These scores reflect performance and are related to annual bonus calculations. FLMs enter data monthly, and the scorecards are used as a management tool. An example scorecard checklist is as follows:

Objective:

To assure that scorecard process and metrics are hardwired

Process
Design your scorecard
Monthly, use the checklist to help you keep it updated
If you have problem areas, contact appropriate support

### Outcomes:

Needed information is accurate and up to date
Information can be trusted when action is needed
Improvements can be easily tracked.

High Medium Low Assessments—Table 2 identifies the profiles for high, medium and low performers and provides a rating system for managers to evaluate performance. Based on ratings, individuals are coached on ways to improve performance. This document and process is part of an individuals career management process.

SMART is an acronym used as an aid to appropriate goal setting. It stands for:

S—smart
M—measurable
A—attainable
R—reasonable
T—timely.

APR—acronym for Annual Progress Review. This is a client review process that provides a retrospective view of operations and contractual obligations over the past 12 months of the contract year. A document is created that reviews value delivered, assesses actual performance vs. goals or plan, and is designed to provide client contacts with a snapshot of activity over the past year.

MJR—acronym for Monthly Joint Review. This is a client review process that occurs monthly to outline activities over the past 30 days, value delivered, and set forth future action plans. There also is an assessment of actual performance vs. monthly targets.

QBR—acronym for Quarterly Business Review. This client review process occurs quarterly to review activities over the past 90 days, value delivered, and set forth future action plans. There is also an assessment of actual quarterly performance vs. quarterly targets.

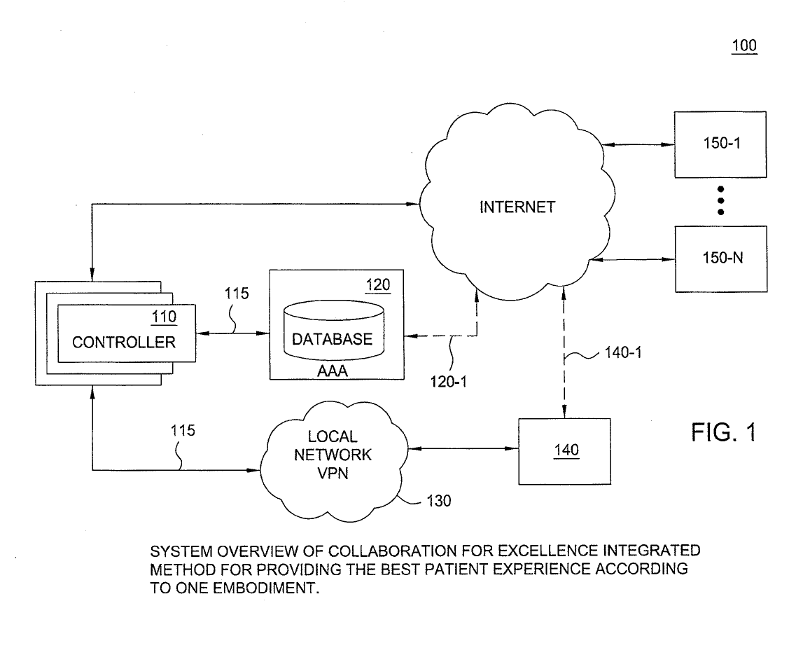

FIG. 1 depicts a block diagram of the Collaboration for Excellence system according to one embodiment. Specifically, FIG. 1 depicts a Collaboration for Excellence system comprising a controller 110, a database and an authorization, authentication, accounting (AAA) server 120, one or more target entities 150-1 to 150-N, local network (Virtual Private Network—VPN) 130 and client system 140. Controller 110 is a server or any computer adapted to implement the Collaboration for Excellence system as described herein, the controller allows remote users/clients 150 access to the system, controls database (AAA) 120 and remote administration 140. The function of the controller can be centralized or distributed as known to an artisan of ordinary skill in the art. Access to the system typically requires a personal computer. Generally speaking, any Internet enabled device such as personal digital assistant (PDA), cellular telephone and the like capable of accessing the Internet may implement the various embodiments described herein. While personal computers are generally discussed within the context of the description, the use of any device having similar functionality is considered to be within the scope of the present embodiments. In one embodiment, link 115 extends over great distance and is a cable, satellite or fiber optic link, a combination of such links or any other suitable communications path. In other embodiments, link 115 extends over a short distance.

In one embodiment, database (AAA) 120 communicates directly with the controller. In another embodiment, database (AAA) 120 communicates with the controller via path 120-1 to the Internet or equivalent. In other embodiments the two methods are utilized concurrently providing a robust path with redundancy. In yet another embodiment, security (encryption) and throughput may determine the actual implementation. The architecture's flexibility allows for multiple controllers to accommodate access capacity, fail-over redundancy, and security or future expansion.

In another embodiment, access to the system by personnel or system administration within the facility is limited to physically accessing the controller. In another embodiment, access to the system by personnel or system administration is done remotely via local network 130 and device 140. In yet another embodiment, access to the system by personnel or system administration is done remotely via path 140-1 to the Internet.

Generally, the process starts with a cultural assessment, which is performed to assess patient care unit/department readiness for implementing new program initiatives, identify potential barriers to change and develop contingency plans to remove or work around the barriers. In addition, the assessment identifies the strengths and support systems of a patient care unit/department in supporting new program initiatives. These strengths are leveraged in implementing new initiatives.

The Culture Assessment is a tool that is based upon Marvin Weisbord's “Six-Box Model” for diagnostic framework in identifying organization, department, or group/team readiness for change and transformation. The emphasis placed in the culture assessment is on teamwork, collaboration and communication. The six key categories of the assessment include: purpose, structure, relationships, rewards, leadership and helpful technologies. The purpose of conducting a culture assessment is to evaluate the patient care unit/department readiness for implementing new program initiatives, identify potential barriers to change and develop contingency plans to remove or work around the barriers. In addition, the assessment identifies the strengths and support systems of a patient care unit/department in supporting new program initiatives. These strengths are leveraged in implementing new initiatives. Structure addresses the division of work and how problems are addressed. Relationships focus on how conflict is managed and information communicated. Rewards look to the existence of incentive for doing all that needs doing. Leadership determines whether someone is keeping in balance, setting focus and direction. Helpful Mechanisms address whether there are adequate coordinating technologies and processes. Each of above sections includes specific questions that are asked in obtaining candid feedback from employees.

Purpose addresses the mission/goal(s). Structure addresses the division of work and how are problems addressed. Relationships concentrate on how conflict is managed and how information is communicated. Rewards addresses the issue of incentive and answers the question: is there incentive for doing all that needs doing. Leadership evaluates whether someone is keeping everything in balance, setting focus and direction. Helpful Mechanisms looks to the issue of adequate coordinating technologies, processes.

The process is divided into three phases: (1) pre on-site phase; (2) on-site phase; and (3) post on-site phase.

In the pre on-site phase a meeting with the Organizational Development (“OD”) professional and the lead contact is scheduled (either in person or via phone) to discuss the goals and desired deliverables. At this time the units/departments to be included are identified. Any unique situations or issues are shared to ensure that the OD Professional(s) conducting the assessment can be sensitive to those issues and ensure the most meaningful report and best possible experience for the organization and participants. The goals and timeline are agreed to and dates for the onsite visit are identified. The tool used to gather information for the assessment is shared; however, this tool is not to be shared with participants to avoid “over thinking” and canned or prepared answers. Sample letters, which can be used to prepare the other members of leadership and the participants for the on-site assessment. What segmentation of the findings will be needed is discussed at this time. Are there any units/divisions, which need to be reported separately or can all of nursing units be reported in together.

During the on-site phase, upon arrival to the hospital the OD Professionals will be given a workspace and appropriate ID to ensure proper access to units/divisions keeping within hospital policy. The schedule for interviews is reviewed the start of day one with a contact person identified for changes as needed to meet the potential changes of activity on a unit or area. The nursing culture assessment is conducted through individual and group interviews by the OD professional(s). Individuals and groups are encouraged to be candid in their response and feedback to questions. Interviews usually last approximately 45 min to 1 hour depending on whether it is a group or individual interview. Interviews are usually scheduled every 90 minutes in agreed upon time frames. Every effort is made to accommodate participation from all shifts. The space identified for the actual interviews is one where noise is controlled as much as possible and the ability to be “overheard” is minimized. There is no right or wrong answers to the questions, and confidentiality is stressed. Prior to leaving the hospital the OD Professional will debrief with high level findings and review the report format and proposed timeline for completion of the formal summary document

This last step can be characterized as the post on-site phase. Once all interviews are completed, results of the interviews are collated, and a summary with recommendations by the OD professional is prepared. This information is shared with the identified leadership. This feedback is candid, honest and confidential. It is a “holding up of the mirror” to reflect the strengths and opportunities for improvement in managing change and transition. The results of all individual patient care units are collated and summarized with recommendations by the OD professional to provide a picture of the overall patient care department's strengths and opportunities. Information on specific units will be provided as agreed to during the pre on-site discussion. Depending upon the number of patient care units and people interviewed, the entire assessment process from beginning to end may take anywhere from 10 days to 3 weeks.

In assuring an efficient and successful on site culture assessment, the following support is needed. First, the client will prepare and distribute an internal communication to their organization outlining the purpose of the assessment at least one week prior to the Organization Effectiveness Specialist arrival. A sample communication can be provided. Second, one hour interviews need to be scheduled with the following key leaders: (a) Chief Executive Officer (if available); (b) Chief Operating Officer; (c) Chief Nursing Officer; (d) Vice President/Director of Human Resources; (e) Director, Quality/Performance Improvement; (f) Vice President over Support Services involved; and (g) The Director(s)/Manager(s) over departments involved. Third, one hour interviews with the following employee groups with each session having between 3-10 participants: (1) Representatives from the nursing staff, including all shifts and roles and (2) Representatives from Support Service front line staff from each of the identified support service departments to be involved. Fourth, with the exception of executive leadership, interviews need to be scheduled in the same location for efficient use of Organization Effectiveness Specialist time. Fifth, the finalized meeting schedule needs to be provided to the Organization Effectiveness Specialist upon arrival to organization. In addition, the name and phone number of a contact person (s) is also needed in the event of questions or concerns. A sample schedule can be provided. Sixth, interviews are scheduled.

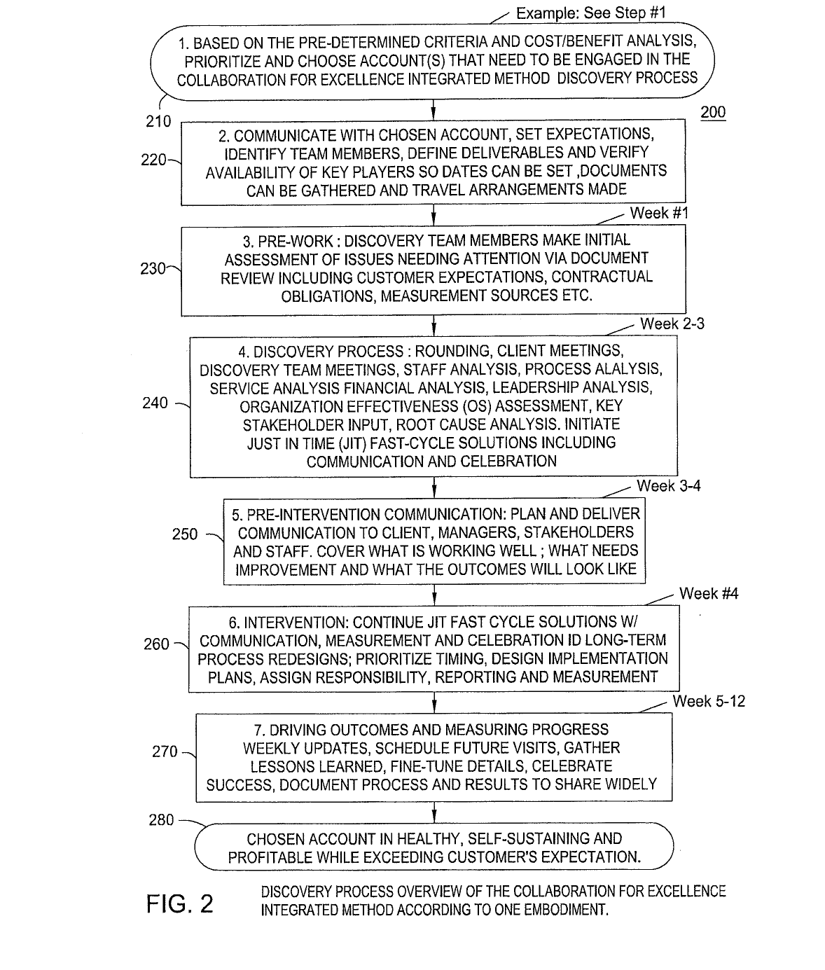

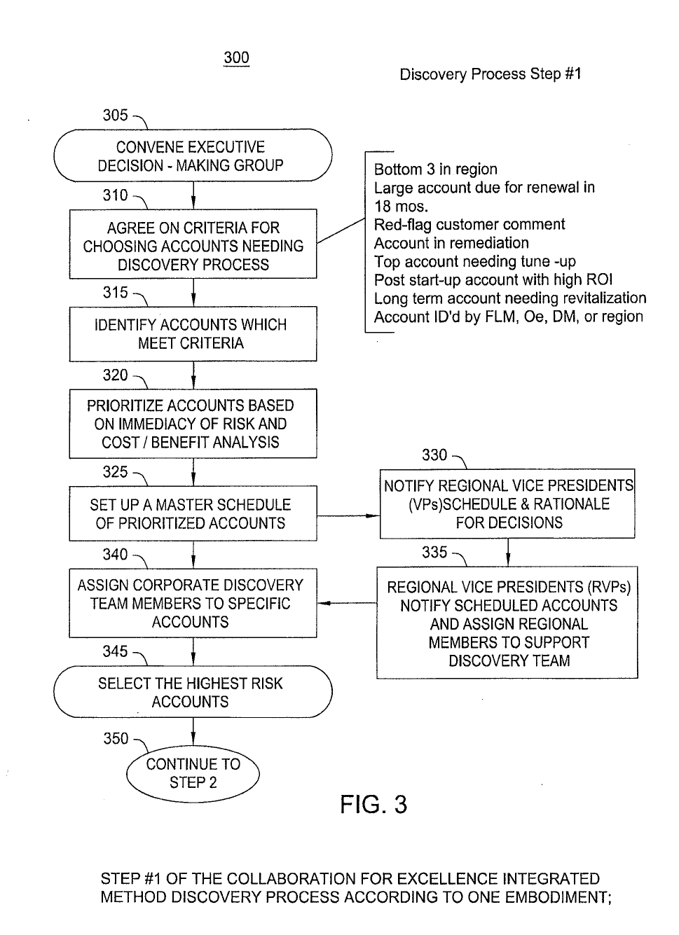

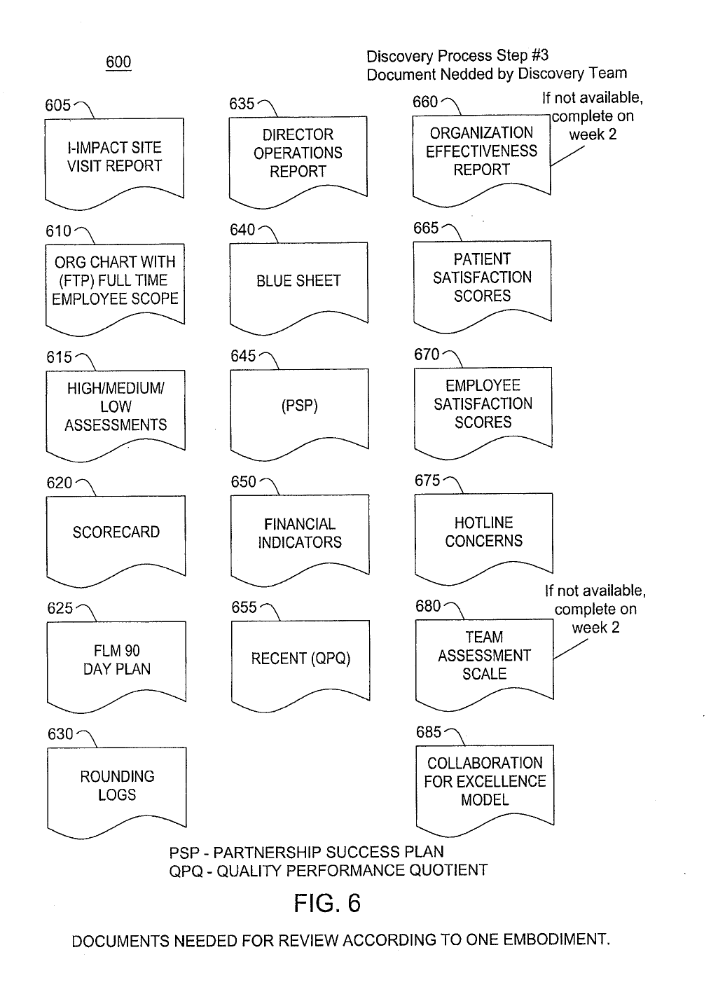

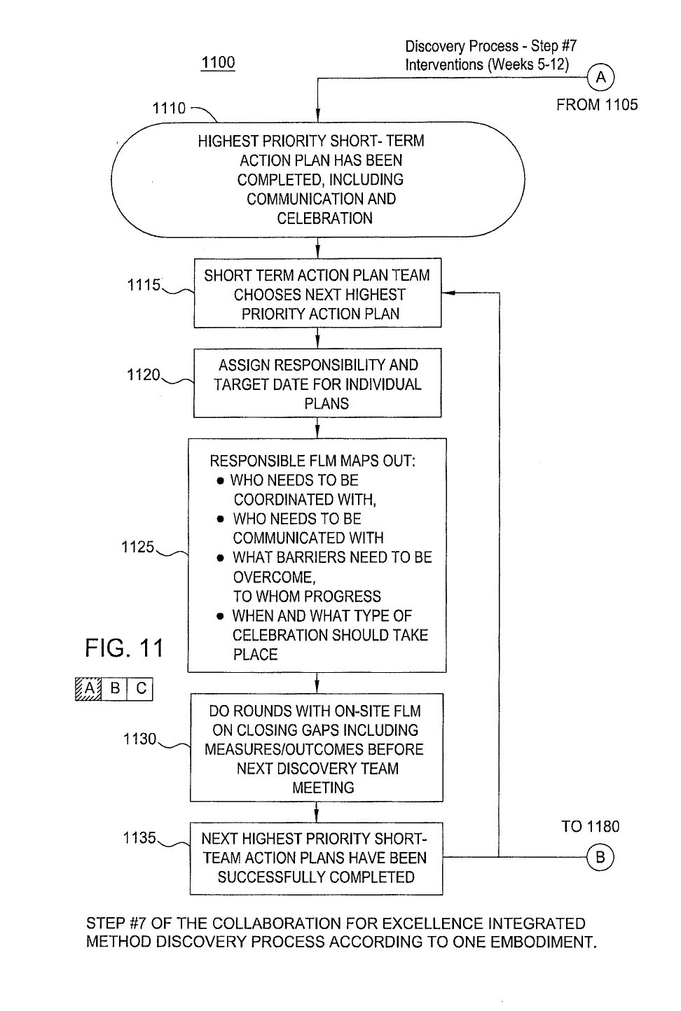

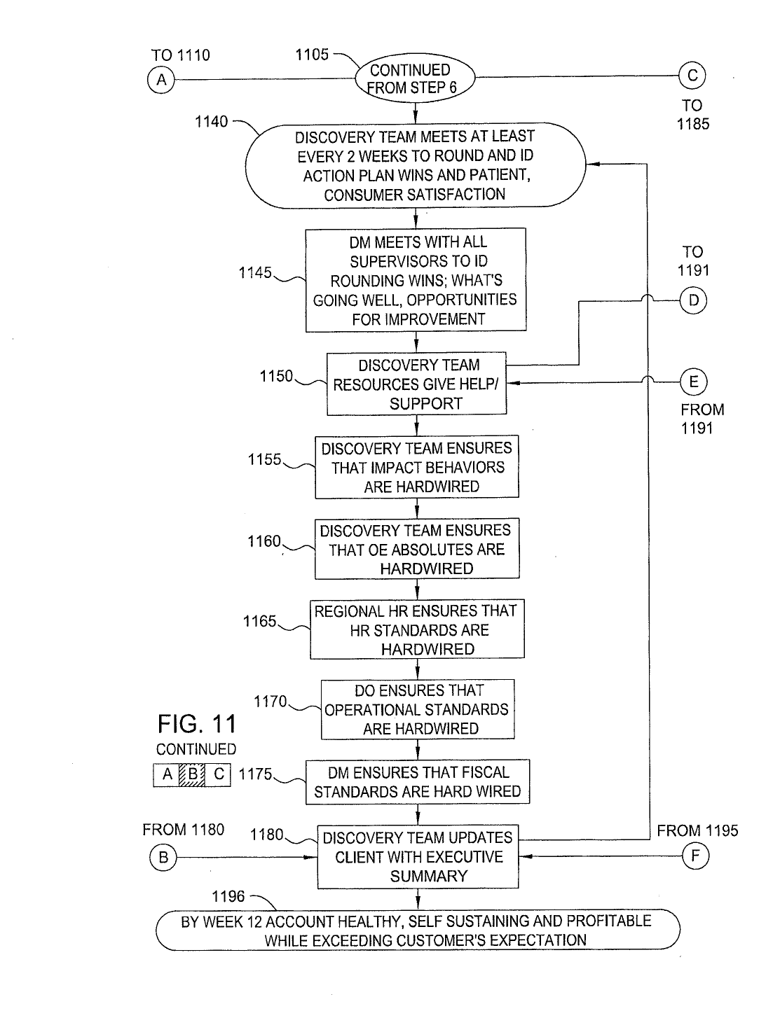

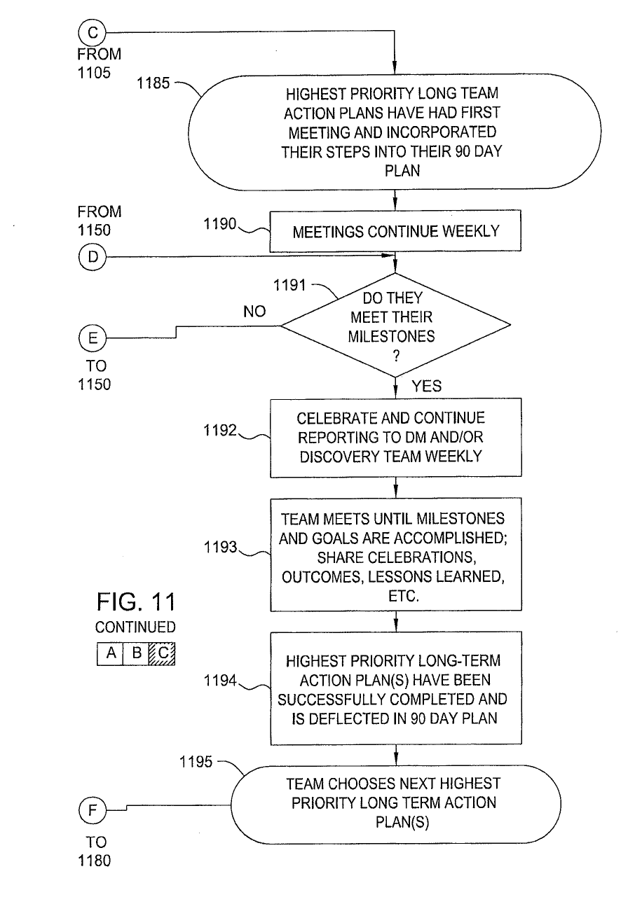

FIG. 2 depicts the Discovery Process Overview of the Collaboration for Excellence Integrated Method according to one embodiment. A detailed description regarding the plurality of actions involved in the process is set forth below. Specifically, sub-step 210 begins the process. The actions necessary to achieve the objectives outlined in sub-step 210 are described in FIGS. 3-11. Discovery Process Step #1 is detailed in FIG. 3 and the last step, namely Step #7 in the process is described in FIGS. 11A-11C. The process spans a 12-week period during which the seven (7) different discovery process steps are executed. In sub-step 210 of FIG. 2, a target entity or potential client or account is chosen. Sub-step 220 describes the actions taken subsequent to accomplishing the objectives of sub-step 210. An action plan is designed for the entity selected in sub-step 210. The documents that are called for in sub-step 220 are listed in FIG. 6. Sub-step 230 entitled: Pre-Work describes the initial assessment procedure. The documents referred to in the preceding step are reviewed in sub-step 230. Sub-step 240 describes the actual discovery process. Sub-step 250 outlines the pre-intervention communication phase of the process. Sub-step 260 describes the actual intervention phase of the process. In sub-step 270, the outcome is captured and progress is measured. Finally, sub-step 280 describes the continuous monitoring phase of the process. In other embodiment, the process is tailored to an organization size, request, objectives, strategic goal or as directed by the organization.

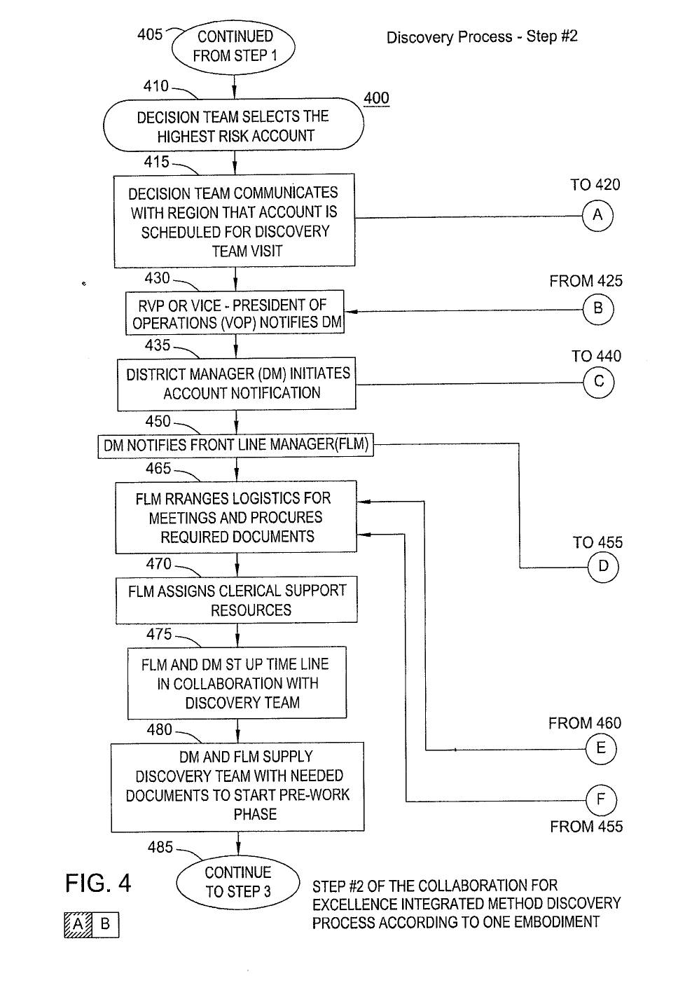

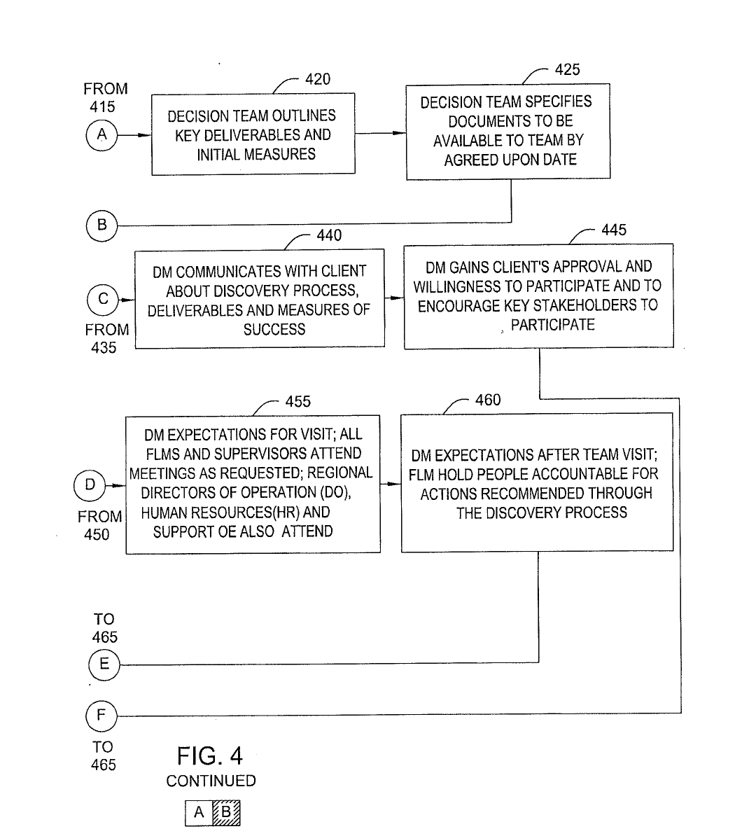

FIG. 3 depicts Step #1 of the Collaboration for Excellence Integrated Method Discovery Process according to one embodiment. Specifically, FIG. 3 details the actions taken in this phase of the discovery process. In sub-step 305, the stakeholders meet to agree on which account or accounts to subject to the discovery process. In sub-step 310, the determinative criteria are agreed upon. In sub-step 315, the accounts meeting the agreed upon criteria are identified. In sub-step 320, a priority is outlined. In sub-step 325, a tentative schedule is set up. The schedule is subject to variations based on any number of unforeseen circumstances. In sub-step 330, the concerned parties are informed and appropriate steps are taken. In sub-step 340, team members are assigned to service the chosen account or accounts. In sub-step 345 the highest risk accounts are selected. The process continues to step 2 as shown in FIGS. 4A and 4B.

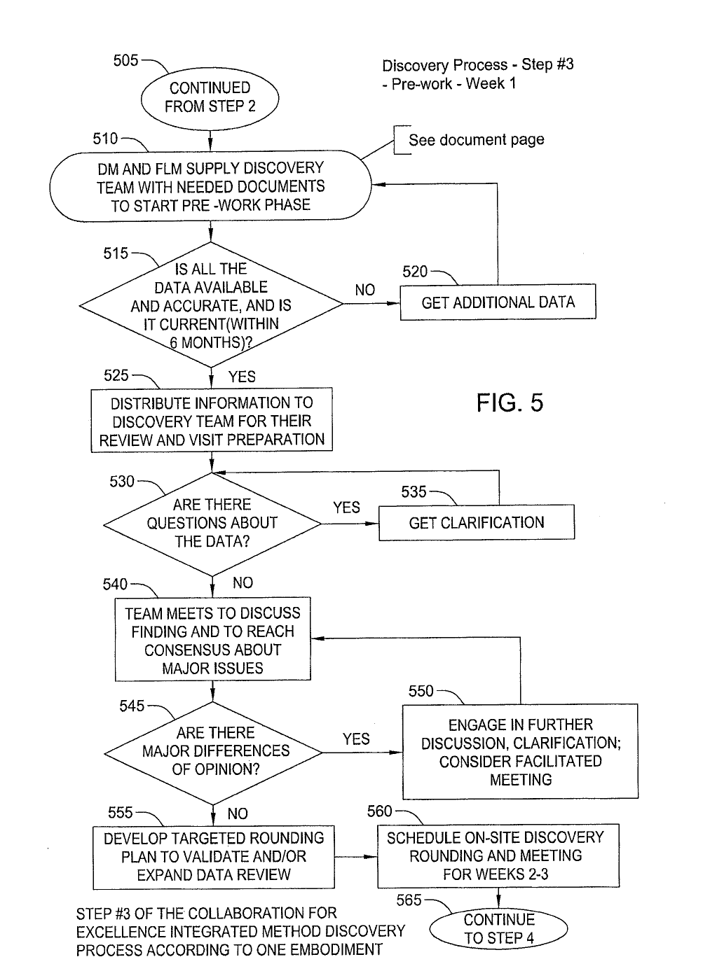

FIGS. 4A and 4B depict Step #2 Flow Chart of the Collaboration for Excellence Integrated Method Discovery Process according to one embodiment. In sub-steps 410 and 415, the highest risk account is selected and the concerned parties are notified as articulated above. In sub-steps 420-475, the involved parties are informed of key deliverables and documents needed and resources are assigned. Particularly, in sub-step 440 a District Manager (DM) communicates with the client about the discovery process, deliverables and measures of success. A District Manager (DM) provides immediate supervision and leadership for client locations they manage. They are responsible for helping coach and train their managers. Front Line Managers (FLMs) report to District Managers, chiefly based on geography. FLMs are on-site managers responsible for day-to-day operations. In sub-step 455, Regional Director of Operations (DO) attend the meeting initiated by the DM. DOs report to service line leaders for patient and retail food & nutrition services, EVS, facility management or Clinical Technology Services (CTS). These titles vary from organization to organization. Adaption to a specific organization operation would be necessary. In sub-step 480, the pre-work phase is ready to be initiated. The process continues to step #3 as shown in FIG. 5.

FIG. 5 depicts Step #3 Flow Chart of the Collaboration for Excellence Integrated Method Discovery Process according to one embodiment. In sub-steps 510-550, the documents provided are inspected for accuracy and a targeted rounding plan is established if the team agrees that the data meet certain predetermined criteria. In sub-step 560, an on-site discovery rounding and meeting is schedule for the coming weeks. The documents needed are listed in FIG. 6.

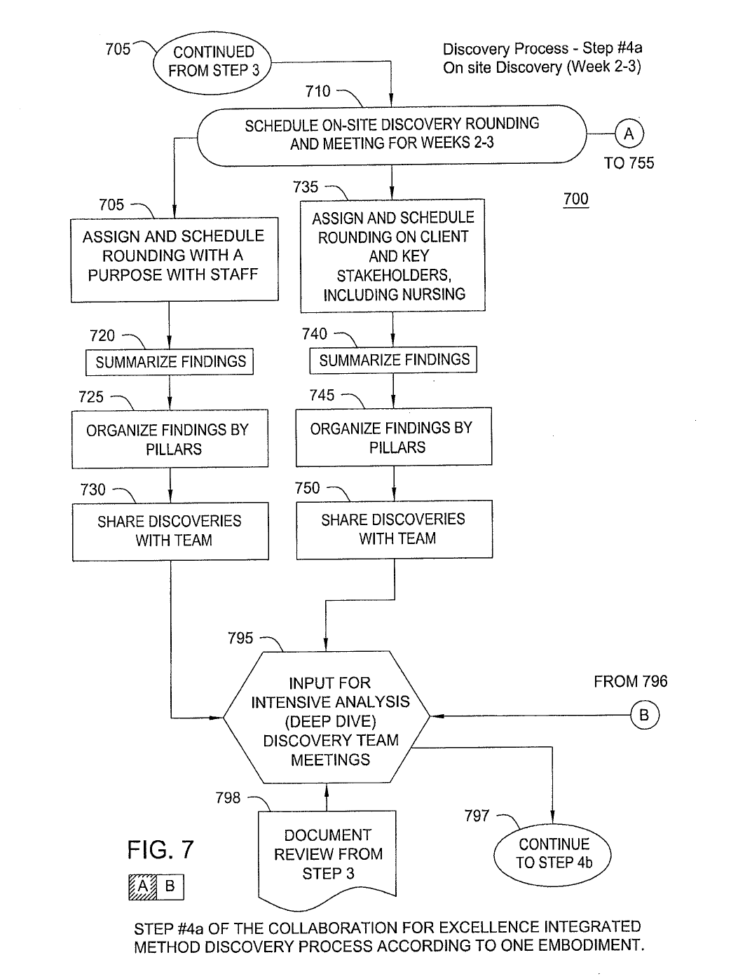

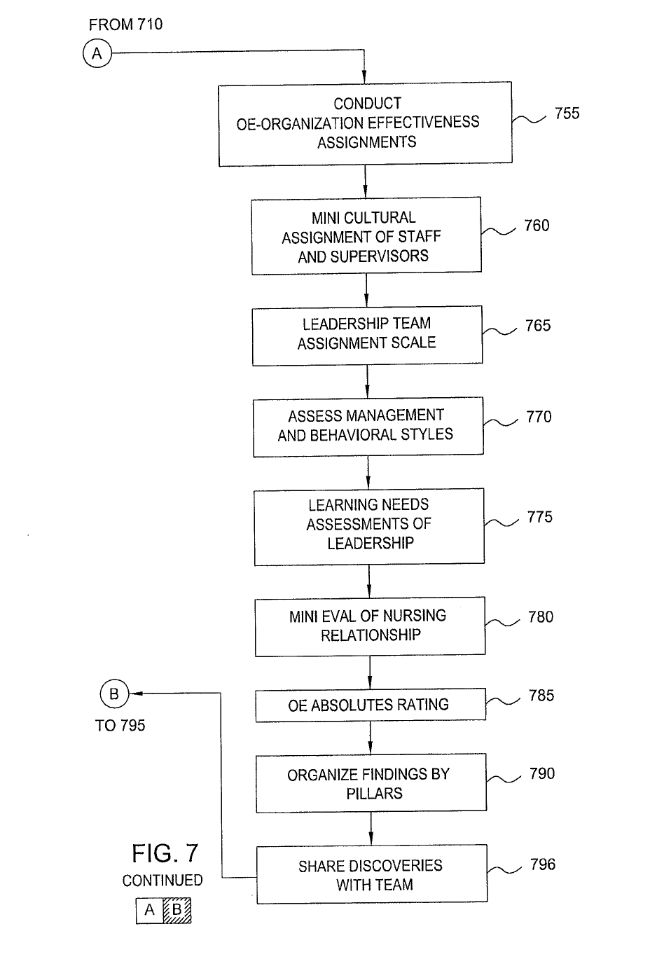

FIG. 6 depicts the Documents Needed for Review according to one embodiment. The list of documents in FIG. 6 is not exhaustive. The team may tailor the documents needed based on the chosen account specifics. For example, a scorecard (620, 665, 670) provides monthly snapshot of how the organization is performing against a targeted goal. A High Medium Low (HML) Evaluation Tool 615 outlines different categories while associating with each of said categories a ranking number. For example, “1” may be designated as Low, “2” may be designated as Medium and “3” may be designated as High. This is a program that is focused on high, middle, and low performers. Program elements include tips for how to rate employees; how to re-recruit high performers by giving specific positive feedback about what they do well; how to support-coach-support middle performers to retain them as valuable employees and identify areas for development; and how to have a difficult conversation with low-performing employees so that the employee understands what has been observed, what needs to be done, and the consequences of continued poor performance. Partnership Success Plan (PSP) 645 is a program designed to focus an organization's managers on the needs, expectations, and satisfaction levels of their clients and customers. As a step-by-step guide, PSP is utilized to build deep and lasting partnerships with clients. It is a continuous, looped process that can be implemented every day. PSP should ultimately guide thoughts and actions regarding the management of client and customer relationships, becoming a part of the consciousness of the manager along the way. PSP comprises process steps, input, process and output. The process steps comprise client expectations, invent solutions, measure value and communicate results and implement. Inputs are recorded in the input column, the process is described and outputs are clearly articulated. For example, an input may be to gather information about the client and the organization as a whole; the corresponding process may be to meet with clients and gather information on expectations and the output may be to understand the client's environment. Quality Performance Quotient (QPQ) 655 is an objective 1,000-point inspection conducted by a qualified Healthcare representative and the target entity's on-site manager. The inspection is used as an objective comparison to measure the progress of your program. The process continues to step 4a as shown in FIGS. 7A and 7B.

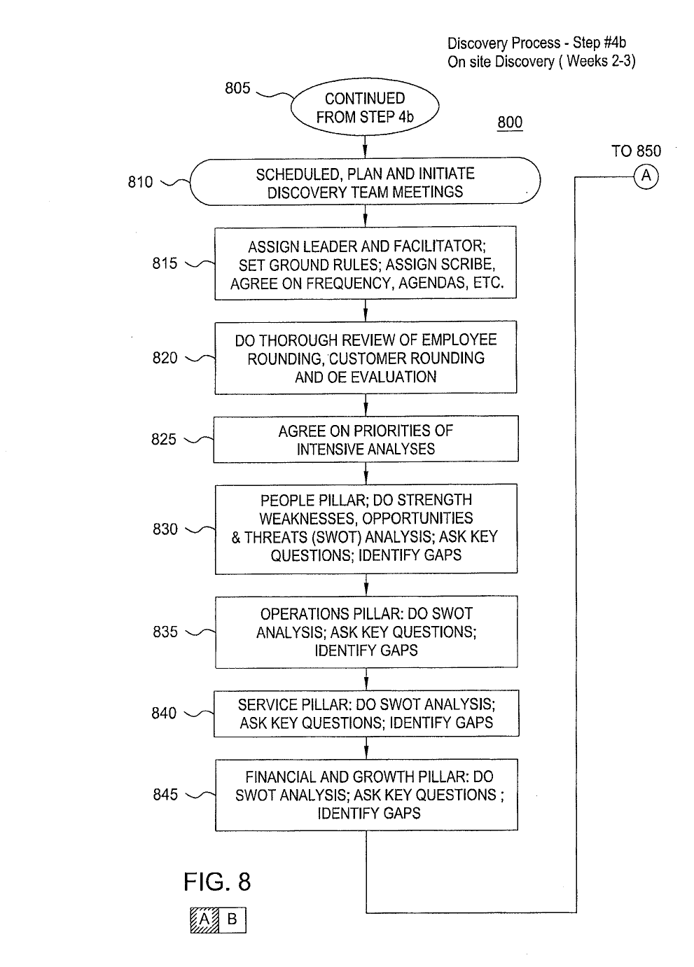

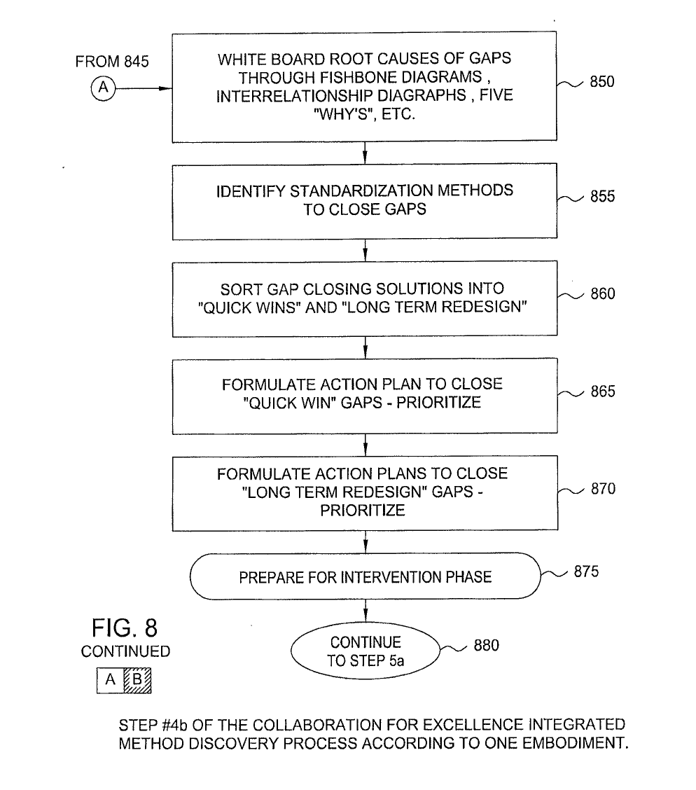

FIGS. 7A and 7B depict Step #4a Flow Chart of the Collaboration for Excellence Integrated Method Discovery Process according to one embodiment. In sub-step 710, an on-site discovery rounding meeting is held. In sub-steps 755-796, a cultural assessment is performed. In sub-steps 705 and 735, two parallel actions are undertaken wherein one involves the staff and the other involves the stakeholders. Sub-steps 720-730 and 735-750 are mirror image of each other. The involved parties are briefed on the team's findings thus far. In sub-step 795, the team gets ready for a deep dive analysis, which includes as input the review of documents listed in FIG. 6 above. The process continues to step 4b as shown in FIGS. 8A and 8B.

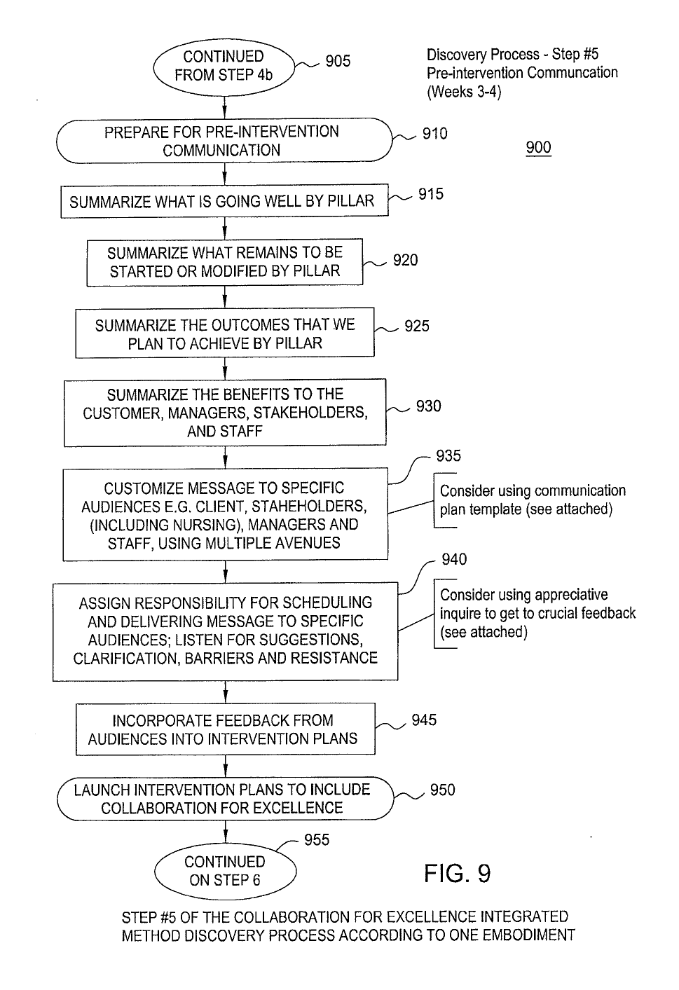

FIGS. 8A and 8B depict Step #4b Flow Chart of the Collaboration for Excellence Integrated Method Discovery Process according to one embodiment. In sub-steps 810-825, the discovery team meetings are planned, scheduled and executed. Particularly, in sub-step 820, the organization effectiveness (OE) evaluation identified in step #3 of FIG. 6 is performed together with a thorough review of employee (customer) rounding. In sub-steps 830-845, people pillar, operations pillar, service pillar, financial and growth pillar are performed. The common thread linking the enumerated pillars is the Strength, Weaknesses, Opportunities and Threats (SWOT) analysis. SWOT is a process undertaken by internal stakeholders of the hospital or target entity, typically nursing and support services in this instance, to identify areas of Strength, Weakness, Opportunity and Threats to building a collaborative work environment. The process involves input from participants in a face-to-face meeting in which attributes are discussed, reviewed and finally agreed upon relating to each dimension of the SWOT (strength, weakness, opportunity, and threat). The dimensions provide a context for identifying areas to be leveraged (strengths), areas for further development (weaknesses and threats), and identifies opportunities that could result from a more collaborative work environment. These different pillars are in no way limiting. An artisan of ordinary skill in the art may identify other pillars that may be implemented without departing from the spirit of the invention. Sub-steps 850-870 address the gaps identified by the SWOT analysis. In sub-step 875, preparation for the intervention phase is undertaken. The process continues to step 5 as shown in FIG. 9.

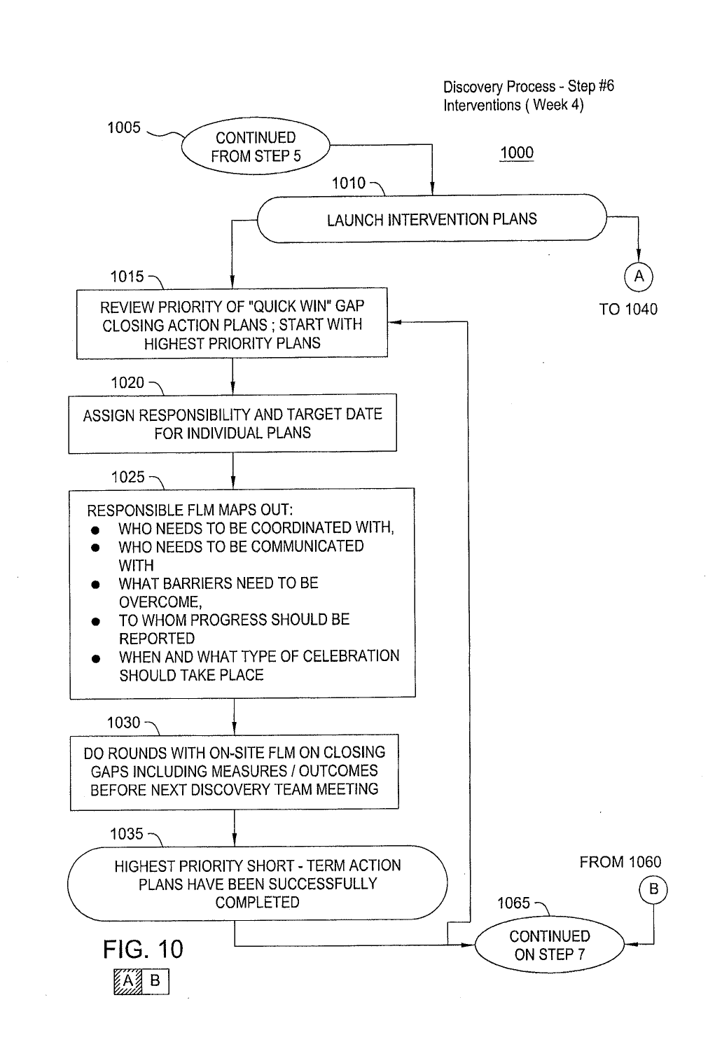

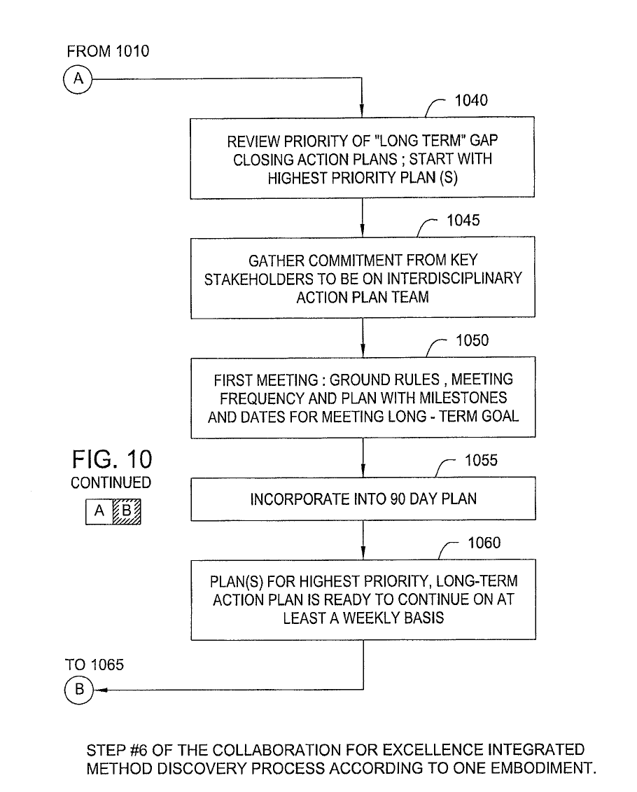

FIG. 9 depicts Step #5 Flow Chart of the Collaboration for Excellence Integrated Method Discovery Process according to one embodiment. In sub-steps 910-930, a comprehensive evaluation of the different pillars is performed. In sub-steps 935-940, an approach to delivering the message is identified. The message is delivered to specific audiences. In sub-step 945, feedback from audiences is incorporated into the intervention plans. In sub-step 950, the intervention is launched. The process continues to step 6 as shown in FIGS. 10A and 10B.

FIGS. 10A and 10B depict Step #6 Flow Chart of the Collaboration for Excellence Integrated Method Discovery Process according to one embodiment. Different gaps are identified. Some gaps may have long term effect; other gaps may have short term effects. The latter may be viewed as “quick win” gap. In this discovery process step, a comprehensive evaluation of the action plans is performed. Different gaps are processed according to a specific method. For example, in sub-step 1050, a first meeting is convened during which ground rules, meeting frequency and plan milestones and dates for meeting long-term goal are identified. In sub-step 1055, these parameters are incorporated into a 90-day plan. In sub-step 1060, the highest priority plan is ready to continue on at least a weekly basis. In sub-step 1065, the process continues to step 7 as shown in FIGS. 11A, 11B and 11C.

FIGS. 11A, 11B and 11C depict Step #7 Flow Chart of the Collaboration for Excellence Integrated Method Discovery Process according to one embodiment. Now that the highest priority long-term action plan has been completed, in sub-steps 1115-1130 the next highest priority short-term action plan is executed. In sub-steps 1140-1145, the discovery team and the district manager (DM) hold separate meetings to identify action plan wins, opportunities for improvement and assess patient/consumer satisfaction. The discovery team resources provide support. In sub-steps 1155-1175, the discovery team ensures that the new approach is anchored within the operational apparatus of the target entity. By week 12, the target entity is healthy, self sustaining and profitable.

In one embodiment, the Nursing Satisfaction with Support Services Survey (NS3 Survey, by Intelliscan, incorporated by reference herein in its entirety) is performed on-line. In another embodiment, the survey is performed in a traditional manner. This survey application includes the following components: (1) An online enrollment screen, which captures demographics of the participating hospital (health care environment) and the point of contact for the survey process (see below); (2) Survey questions for the “traditional eight” support services that are randomized as each respondent accesses the survey from a survey link provided to them by the hospital's point of contact. Each respondent has the ability to respond to questions for two (2) services with an option to complete a third; (3) Automated emails to the hospital's point of contact containing:
Links to the online survey to be forwarded to all staff nurses with suggested email copy to encourage participation;
Updates to participation with suggested email copy as reminders to be sent to staff nurses to encourage participation; and
   (4) Template report format, which reports the results of the survey to provide prioritization against the question set. The survey results are tabulated for importance, performance, and a collaboration score. These results serve as a baseline tool for Collaboration for Excellence activities. A “toolkit” will accompany the NS3 rollout to members. In addition to the above technology component, members will have access to Frequently Asked Questions (FAQs) about the survey and process, communication tools to enhance participation, and background information about the survey development. These tools are accessed online via www.aone.org. Other tools such as self-assessment (impact) tools can be utilized. For example, the “Self-Assessment Tool for Guiding Principles for Relationships among Nursing and Support Services in the Clinical Setting” (ARAMARK, 2008) can be used in conjunction with the “Guiding Principles for Relationships among Nursing and Support Services in the Clinical Setting” (The American Organization of Nurse Executives), both of which are incorporated by reference herein in their entireties.

In one embodiment, the NS3 survey presents the results in a report format. It is a comprehensive report with six (6) major categories: (1) Understanding the Study; (2) Hospital Key Performance Indicators; (3) Importance Ratings; (4) Performance Ratings; (5) Make an Impact on and (6) Impact Summary. A detailed description of each section follows. The Understanding the Study section comprises three (3) subsections: an objective subsection, a tool to impact outcomes subsection and a benchmark success subsection. As the name implies, the objective lays out the goal of the survey. For example, the objective may state: the NS3 survey is designed to develop a better understanding of the impact that support services has on nursing satisfaction and their ability to focus on clinical tasks. This report will provide key insights that you can use to improve the effectiveness of support services and the relationship with nurses, including: a tool to impact outcomes, which specifies targeted action areas to influence nurse and support service outcomes; satisfaction with support services and collaboration between nurse and support services; Benchmark success, which tracks the progress of support services at the hospital under consideration against a national sample and the change in support services over time.

In another embodiment, the survey is modified such that certain components of the survey are tailored to a specific facility. For example, the number of support services may increase or decrease depending on the facility. The automated e-mail may be adapted to include other variables. The survey is designed to adapt to the realities of the facility and of the day.

The Hospital Key Performance Indicators section tracks the overall performance of Hospital or Facility A against national sample and the overall hospital scores over time as future reports are received. Two major parameters are conveyed: “Satisfaction,” which is an indicator of important nurse behavioral outcomes such as retention, workgroup morale and favorability toward Hospital A; and “Collaborative Efforts,” which is an indicator of important healthcare outcomes such as nurse productivity, clinical outcomes and patient satisfaction. The result is presented in a graphical illustration or another suitable format.

The Importance Ratings Section conveys the result of the study where Nurses were asked to rate how important certain behaviors/actions are for Hospital A employees to display. The result is presented in a table format or another suitable format. To improve nurse satisfaction with Hospital A, focus on the concerns that are listed first (at the top of the list).

The Performance Ratings conveys the result of the study where Nurses were asked to rate the performance of certain behaviors/actions for Hospital A. Focus efforts on improving items listed first (at the top of the list) that also have the lowest performance ratings.

The “Make an Impact on” Section plots the results of the study. It comprises three (3) distinct subsections: (1) The Areas Nurses Think are Most Important; (2) Satisfaction with Service Level; and (3) Collaboration between Nurses & Support Services. The plot for the first subsection focuses on: behaviors/actions, which have the greatest top of mind importance to nurses: (1) “Key Strengths” to establish credibility among nurses; and (2) Improve “Key Weaknesses” to demonstrate that Hospital A invests in the areas nurses care about the most. The plot also shows certain nice-to-have amenities and low priority weakness.

The plot for the second subsection of the “Make an Impact on” Section focuses on: (1) Behaviors/actions, which have a greater impact on nurses' satisfaction with Hospital A (2) Correcting “Key Weaknesses” and (3) leveraging “Key Strengths” to achieve overall satisfaction with Hospital A.

The plot for the third subsection of the “Make an Impact on” Section focuses on behaviors/actions, which have a greater impact on collaboration between nurses and Hospital A staff. It provides the following recommendation: (1) Maximize your impact on interdepartmental collaboration by correcting “Key Weaknesses” and (2) leveraging “Key Strengths.”

The Impact Summary Section presents a tabulated result of the survey. It prioritizes an Action Plan for Hospital (Facility) A. Specifically, it looks for overlapping areas of strengths and weaknesses as targeted areas to improve and promote.

The foregoing is meant to exemplify the invention and is not intended to limit it in any way. Those skilled in the art will recognize modifications within the spirit and scope of the invention as set forth in the appended claims. All documents cited herein are hereby incorporated by reference in their entireties.

TABLE 1
The Partnership Success Plan Process

| | | | | Communicate | |
|---|---|---|---|---|---|
| | Client Expectations | Invent solutions | Measure Value | Results | Implement: |
| Step | Process Step #1 | Process Step #2 | Process Step #3 | Process Step #4 | Process Step #5 |
| INPUTS | 1. Identify the key client(s) | The prioritized expectations list | Solutions & initiatives | Metrics & reporting | The output of all |
| | for | developed in process | Identified in process | Methodology | Previous process steps |
| | the service | Step 1 | Step 2 | developed | |
| | 2. Gather information about | | | In step 3 | |
| | the client and the | | | | |
| | organization | | | | |
| | as a whole. | | | | |
| | a. Mission and Vision | | | | |
| | b. Goals & objectives | | | | |
| | c. Personal wins | | | | |
| | d. Critical success | | | | |
| | factors | | | | |
| | e. Economic condition | | | | |
| | f. Growth or decline | | | | |
| | g. Current focus & | | | | |
| | initiatives | | | | |
| | h. New projects | | | | |
| | 3. Pre-profile client | | | | |
| | expectations | | | | |
| | From data gathered | | | | |
| | 4. Plan meetings with client | | | | |
| PROCESS | 1. ID all your Client(s) and | 1. ID & select group | 1. ID best measures | 1. Determine people | 1. Develop overall |
| | Influences | members for specific | to monitor the processes | and groups to be | implementation |
| | 2. Meet with Client & gather | expectations | for performance and | communicated with | 2. Develop feedback, |
| | Information on expectations | 2. Create a list of variables | control | 2. Determine the | monitoring & control |
| | 3. Develop updated profile | (traits) for each expectation | 2. Develop measures for | frequency of | plan |
| | of | 3. Discuss relationship | client satisfaction | communication | 3. Meet with client to |
| | Client expectations | between expectations and | 3. Develop measures for | 3. Determine the form | get improvements & |
| | 4. Prioritize expectations | variables with work group | Cost control of each | of communication | approvals on |
| | 5. Meet with client again to | 4. Prioritize variables by | process | 4. Develop client | implementation plan |
| | Verify and confirm | impact to outcome | 4. For each measure, ID | report card format | 4. Implement new |
| | expectations | 5. Brainstorm design ideas | the minimum & | 5. Finalize report card | processes according to |
| | 6. Produce finalized | & concepts that link the | maximum performance | 6. Develop overall | developed plans |
| | expectations list | variables to outcomes, | performance standard | communication plan | 5. Implement |
| | | performance standard and | that provides the decided | 7. Meet with client to | communication plan |
| | | expectations | upon service concept | get agreement on | 6. Implement |
| | | 6. ID most impactful | | communication plan | communication and |
| | | solutions (Prioritize) | | 8. Refine | measurement plan |
| | | 7. Conduct a cost/benefit | | communication plan | |
| | | analysis | | | |
| | | 8. Modify processes as | | | |
| | | necessary for performance, | | | |
| | | efficiency or cost | | | |

TABLE 2
HML Performance Evaluation Tool

| | H = 3 M = 2 L = 1 | H = 3 M = 2 L = 1 | H = 3 M = 2 L = 1 |
|---|---|---|---|
| Category | Shaping | Inspiring | Delighting |
| | *Business Acumen | *Visionary Leadership | *Customer/Client Insight |
| | *Strategic Agility | *Leveraging Differences | *Building Performance-Based Relationships |
| | *Courage & Conviction | *Building People Capability | *Organizational Collaboration |
| “H” | This individual has an extremely solid | This individual is extremely adept at | This individual strongly possesses a genuine desir |
| | understanding of the broader market | improving the effectiveness and | and ability to discover the changing needs of |
| | picture and ARAMARK's capabilities, | productivity of the team by providing | ARAMARK's customers/clients and is very |
| | as well as the strong ability to “pull it | clear direction and creating a positive | adept a responding accordingly with solutions |
| | all together” to make the right strategic | work environment that energizes and | that target these needs. |
| | and tactical business decisions. | engages the team members. | |
| | This individual responds extremely well | This individual is extremely adept at | This individual is extremely adept at developing |
| | to the pressure of constant change by | openly embracing and respecting | an maintaining strategic relationships that can |
| | eagerly re-examining how they, their | differences and seeking opportunities to | further the mission and business of ARAMARK |
| | team, and the business may need to | grow diversity as a source of | on an ongoing basis. |
| | adapt and best respond to opportunities | competitive advantage for ARAMARK. | |
| | or challenges. | | |
| HIGH | This individual extremely genuine and | This individual is very concerned with | This individual is extremely adept at promoting a |
| PERFORMER: | authentic when interacting with others | developing future talent for | spirit of cooperation across ARAMARK in order |
| | in a way that lets others know exactly | ARAMARK and is extremely adept at | to best leverage ARAMARK's capabilities and |
| | where they stand. | proactively taking responsibility for | resources to serve client and customer needs. |
| | | others' professional growth | |
| | | and development. | |
| “M” | This individual has a solid | This individual improves the | This individual possesses a genuine desire and |
| | understanding of the broader market | effectiveness and productivity of the | ability to discover the changing needs of |
| | picture and ARAMARK's capabilities, | team by providing clear direction and | ARAMARK's customers/clients and responds |
| | as well as the ability to “pull it all | creating a positive work environment | accordingly with solutions that target these needs. |
| | together” to make the right strategic | that energizes and engages the team | |
| | and tactical business decisions. | members. | |
| | This individual responds appropriately | This individual openly embraces and | This individual develops and maintains strategic |
| | to the pressure of constant change by | respects differences and seeks | relationships that can further the mission and |
| | eagerly re-examining how they, their | opportunities to grow diversity as a | business of ARAMARK on an ongoing basis. |
| | team, and the business may need to | source of competitive advantage for | |
| | adapt and best respond to opportunities | ARAMARK. | |
| | or challenges. | | |
| MIDDLE | This individual genuine and authentic | This individual is concerned with | This individual can be relied upon to promote a |
| PERFORMER: | when interacting with others in a way | developing future talent for ARAMARK | spi [symbol] of cooperation across ARAMARK in |
| | that lets others know exactly where | and proactively taking responsibility for | order to best leverage ARAMARK's capabilities |
| | they stand. | others' professional growth and | and resources t [symbol] serve client and |
| | | development. | customer needs. |
| “L” | This individual does not have a solid | This individual is unable to improve the | This individual does not possess a genuine desire |
| | understanding of the broader market | effectiveness and productivity of the | and ability to discover the changing needs of |
| | picture and ARAMARK's capabilities, | team by providing clear direction and | ARAMARK's customers/clients or respond |
| | or the ability to “pull it all together” | creating a positive work environment | accordingly with solutions that target these needs. |
| | to make the right strategic and tactical | that energizes and engages the team | |
| | business decisions. | members. | |
| | This individual is unable to respond to | This individual does not openly | This individual does not develop and maintain |
| | the pressure of constant change by | embrace or respect differences or seek | strategic relationship that can further the mission |
| | eagerly re-examining how they, their | opportunities to grow diversity as a | and business of ARAMARK on an ongoing basis. |
| | team, and the business may need to | source of competitive advantage for | |
| | adapt and best respond to opportunities | ARAMARK. | |
| | or challenges. | | |
| LOW | This individual is not genuine or | This individual is not concerned with | This individual cannot be relied upon to |
| PERFORMER: | authentic when interacting with others | developing future talent for ARAMARK | promote a spirit of cooperation across |
| | in a way that lets others know exactly | or proactively taking responsibility for | ARAMARK in order to best leverage |
| | where they stand. | others' professional growth and | ARAMARK's capabilities and resources to serve |
| | | development. | client and customer needs. |

Legend
1 = Low
2 = Middle
3 - High
4 to 6
7 to 10
11 to 12 [symbol]
indicates data missing or illegible when filed

TABLE 3
90 Day Goal Setting Guidelines For FLMs

```
OBJECTIVE:
To help you clarify what is a meaningful, measurable goal.
PROCESS:
    Understand the current year's Pillar Goals
    Develop your goal for each Pillar
    Use checklist to review your goal's effectiveness
OUTCOMES:
    Goals will be actionable and measurable
    Action plans will be more clear since goals are measurable
    Points to Remember:
        Keep it simple; no more than 8 goals
        Focus on the goals first to ensure 8 solid, measurable, outcome driven goals
    Setting your Goals:
        Ask yourself why is this a goal?
        What am I trying to accomplish with this goal?
        Is it a goal or is it a task that will get me to a larger goal?
        Is it the right goal that I am measuring?
        Does it add value to my operation or to my client?
        Can I quantify it and measure it?
        Note: If it does not have a value, number, amount, quantifiable outcome...it is
        not a goal! If you can't put a number or value data on a scorecard, it is not a goal.
    Patient Satisfaction Goals:
        Patient Satisfaction goals should measure percentile rank; but baseline, “from”
        and “to” goals need to be present to make it clear and easy to follow.
        Patient Satisfaction goal should be “gap” between current performance rank and
        top percentile (100%); then 10% growth
            For example, it you are in the 46th percentile then you should be 100%
            minus 46% = 54% Gap. Annual goal is 5.4%; Quarterly Goal is 1.35%.
            Note: That may seem like a low goal but if you blow it out; adjust again for
            the next quarter with new goals...we hope that's the case!!
    Operational Goals:
        Operational Goals such as Ops Standards Audits (food), Clinical Productivity
        (Food), and Amendments (CTS) need to be 100% annual goal and 100%
        quarterly goal to meet requirements.
        Operational Goals: 100% on MJR, QBR, APR is the annual goal.
            Quarterly goal should be 100% of what is due that quarter (i.e. 2 MJR's
            and 1 QBR; or 2 MJR's and 1 APR).
            Some of the action steps might include tracking data for reports, keeping
            up with scorecards, rounding and Thank You notes, working with
            Marketing Dept to create professional report, etc
            All goals need to be S.M.A.R.T.
    Financial Goals:
        Financial Pillar: Annual Goal for Revenue and Profit plan should be FLM's annual
        revenue and profit plan (not shared)
        Quarterly Goal should be FLM's quarterly plan (not shared)
        Client Financial goal may be Annual Budget for annual goal and divide by 4 for
        quarterly goal.
        Another goal may be to reduce overtime by a $ amount per month or a number
        of hours per month
Another goal may be to reduce food cost, parts cost, direct expense costs, etc. Just
make it measurable by a annual amount; then break down into quarterly goals.
```

We claim:

1. A collaboration for excellence integrated method for providing the best patient experience, wherein at least one controller is adapted to perform the method, comprising:
selecting a target entity;
designing an action plan;
performing an initial assessment of critical issues; and
driving the outcomes and measuring progress.

2. The method of claim 1, wherein the selection step further comprises determining and prioritizing the target entity based on pre-determined criteria.

3. The method of claim 1, wherein the action plan further comprises pre-intervention communication and intervention

4. The method of claim 1, wherein the performing an initial assessment of critical issues step further comprises performing one or more discovery steps.

5. The method of claim 4, wherein the discovery step further comprises performing one or more activities including analyzes, studies, surveys, evaluations and data collection.

6. The method of claim 5, wherein the discovery step further comprising executing the Nursing Satisfaction with Support Services (NS3) survey.

7. The method of claim 1, further comprising communicating the outcomes of said analyses to said entity.

8. A collaboration for excellence system, comprising:
at least one controller communicatively coupled to one or more target entities wherein the controller is adapted to perform a collaboration for excellence integrated method for providing the best patient experience.

9. The system of claim 8, further comprising a database, accounting, authorization and authentication (AAA) server communicatively coupled to the at the least one controller.

10. The system of claim 8, further comprising a remote access device communicatively coupled to the at the least one controller.

11. The system of claim 8, wherein the controller further performs execution of the Nursing Satisfaction with Support Services (NS3) survey.

12. A computer readable medium for storing instructions which, when executed by a processor, perform the collaboration for excellence integrated method for providing the best patient experience.
